(19) United States
(12) Patent Application Publication
(10) Pub. No.: US 2026/0203038 A1
(43) Pub. Date: Jul. 16, 2026

(54) UPGRADE OF INTERNAL CONTAINER REGISTRY

(71) Applicant: Dell Products L.P., Round Rock, TX (US)

(72) Inventors: Xiang YUAN, Shanghai (CN); Meng ZENG, Shanghai (CN); Chen CHEN, Shanghai (CN)

(73) Assignee: Dell Products L.P., Round Rock, TX (US)

(21) Appl. No.: 19/034,275

(22) Filed: Jan. 22, 2025

(30) Foreign Application Priority Data
Jan. 15, 2025 (CN) 202510069241.X

(51) Int. Cl. G06F 8/65

(52) U.S. Cl. CPC G06F 8/65

(57) ABSTRACT

An information handling system may include a group of nodes including at least one node. The information handling system may be configured to: execute, at a particular node of the group of nodes, a container registry that includes images for a plurality of containerized workloads; cause all nodes of the group of nodes to execute a containerized workload that is an image holder; and upgrade the container registry from an old image to a new image by: storing the old image and the new image in a local physical storage resource of the particular node; executing, by the image holder, the new image; shutting down the container registry that is executing the old image; and starting a new container registry, wherein the new container registry is configured to execute the new image.

### TECHNICAL FIELD

The present disclosure relates in general to information handling systems, and more particularly to techniques for upgrading an internal registry in a containerization system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) or containerized workloads for various purposes. A VM or container may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In both the HCI context and the non-HCI context, workloads may be deployed in a containerized fashion. A containerization platform (e.g., Docker, Kubernetes, etc.) may be used for managing and/or orchestrating containers. Containers generally encapsulate applications and their dependencies, with each container providing a secure and isolated execution environment for the application running therein. For example, a Docker or Kubernetes pod is a group of one or more containers, as well as information specifying how to run those containers.

The example of Docker and Kubernetes as the containerization platform is discussed in detail herein for the sake of concreteness. One of ordinary skill in the art with the benefit of this disclosure will understand its applicability to other platforms and other containerization scenarios, scenarios, however.

A containerization platform may include a container registry, which is used for tracking and distributing the containerized workloads. Some deployments may use an external registry such as Docker Hub, but in some cases (e.g., in a resource-limited multi-cloud system) it may be necessary or preferable to use only an internal registry that is hosted by the same cluster that runs the workloads themselves.

In some implementation, the existence and functionality of this internal registry may be required for proper operation of every pod in the cluster. For example, when a new pod is started, it may pull its container image from the container registry and then start up. Accordingly, if the registry is unavailable, no new pods can be started. This dependence on the registry can cause problems when performing pod upgrades, which are performed by stopping the old version of a pod and then starting a new version. This procedure does not generally cause issues when upgrading most pods, but when the container registry itself is being upgraded, this can create a “chicken and egg” problem.

In particular, once the old version of the container registry is stopped, no new pods (including the new version of the container registry itself) can be started. Further, the time period during which the container registry is unavailable may cause other problems within the cluster.

Accordingly, embodiments of this disclosure provide techniques for upgrading a container registry under these constraints.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with upgrading a container registry may be reduced or eliminated.

In accordance with embodiments of the present disclosure, an information handling system may include a group of nodes including at least one node. The information handling system may be configured to: execute, at a particular node of the group of nodes, a container registry that includes images for a plurality of containerized workloads; cause all nodes of the group of nodes to execute a containerized workload that is an image holder; and upgrade the container registry from an old image to a new image by: storing the old image and the new image in a local physical storage resource of the particular node; executing, by the image holder, the new image; shutting down the container registry that is executing the old image; and starting a new container registry, wherein the new container registry is configured to execute the new image.

In accordance with these and other embodiments of the present disclosure, a method may include an information handling system that includes a group of nodes including at least one node executing, at a particular node of the group of nodes, a container registry that includes images for a plurality of containerized workloads; the information handling system causing all nodes of the group of nodes to execute a containerized workload that is an image holder; and the information handling system upgrading the container registry from an old image to a new image by: storing the old image and the new image in a local physical storage resource of the particular node; executing, by the image holder, the new image; shutting down the container registry that is executing the old image; and starting a new container registry, wherein the new container registry is configured to execute the new image.

In accordance with these and other embodiments of the present disclosure, an article of manufacture may include a non-transitory, computer-readable medium having computer-executable instructions thereon that are executable by a processor of an information handling system that includes a group of nodes including at least one node for: executing, at a particular node of the group of nodes, a container registry that includes images for a plurality of containerized workloads; causing all nodes of the group of nodes to execute a containerized workload that is an image holder; and upgrading the container registry from an old image to a new image by: storing the old image and the new image in a local physical storage resource of the particular node; executing, by the image holder, the new image; shutting down the container registry that is executing the old image; and starting a new container registry, wherein the new container registry is configured to execute the new image.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example architecture, in accordance with embodiments of the present disclosure.

### DETAILED DESCRIPTION

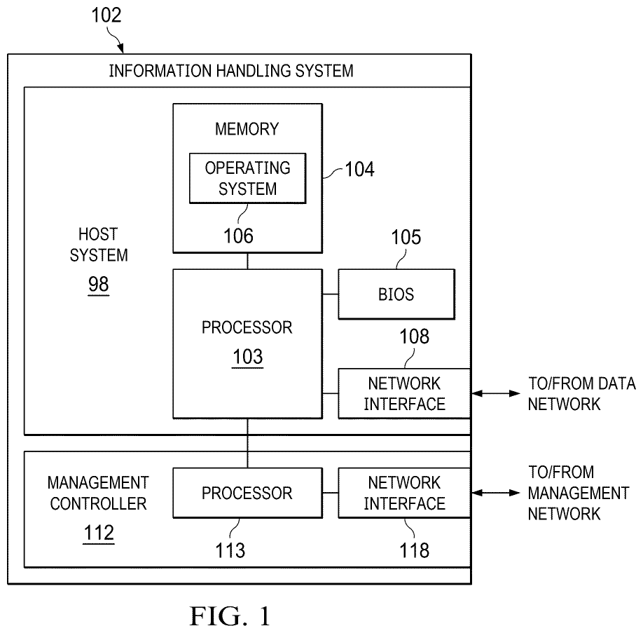

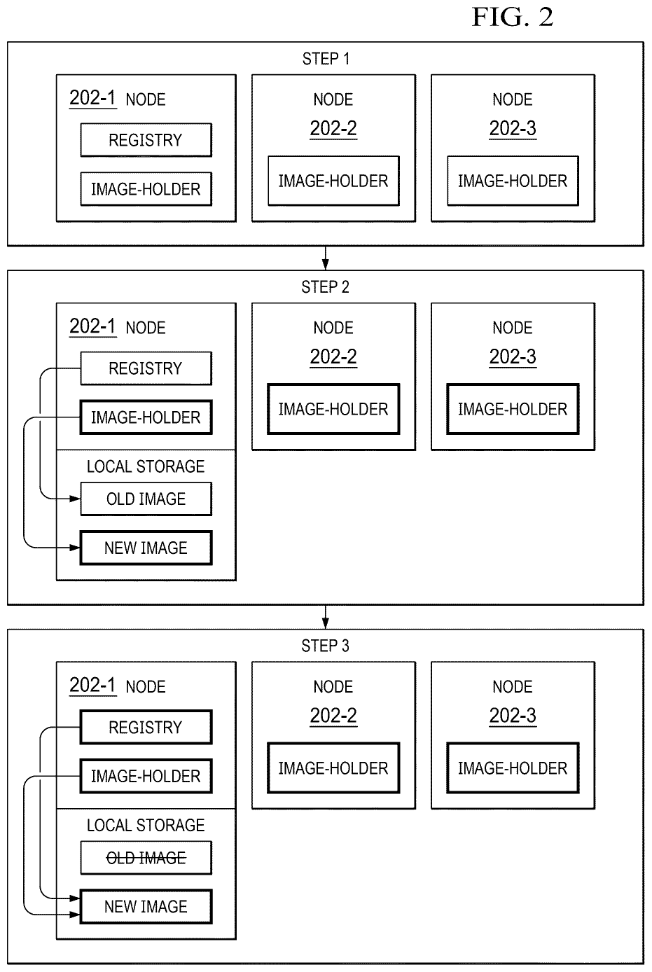

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, information handling system 102 may be a node of an HCI cluster system, running containers under the control of a containerization platform. One of the pods running on information handling system 102 may be a container registry, which provides container images and other services for all of the pods executing in the cluster.

As further discussed above, embodiments of this disclosure are directed to addressing the “chicken and egg” problem of how to upgrade the container registry executing on information handling system 102.

FIG. 2 illustrates an example architecture implementing one embodiment. As shown, the cluster includes three nodes 202-1, 202-2, and 202-3. Node 202-1 is the one that is executing the registry.

Embodiments may leverage a feature known as a “DaemonSet”, which may be used to ensure that all nodes of a cluster run a copy of some workload that is specified by the DaemonSet. For example, as nodes are added to the cluster, the pod specified by the DaemonSet is automatically added to them, and the containerization platform may ensure that the specified pod remains running.

In one embodiment, a DaemonSet may be created that specifies a pod referred to as image-holder, which may have the same underlying container image as the registry itself. This is the situation as shown at Step 1.

When the registry needs to be upgraded from an old version to a new version, both the old image and the new image may be stored in local storage of the node hosting the registry, as shown at Step 2.

Prior to the upgrade, the running registry may continue to refer to and execute the old image. But the image-holder pod may refer to and execute the new image.

Further, the “imagePullPolicy” of the registry may be set to “IfNotPresent”. This setting may prevent the registry pod from attempting to pull its image from the registry, if that image already exists on the node in local storage. This setting allows the registry pod to be upgraded, and the new registry pod may receive its image from the local storage instead of from the inactive registry (which will no longer be running at that time).

At Step 3, the upgrade may be performed. The registry pod running the old image may shut down, and a new registry pod may be started using the new image. The new registry pod may pull its image from the new image in local storage as shown. After the upgrade is complete, the old image may be removed from local storage.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system cluster comprising:
a group of nodes including at least one node, wherein each node in the group of nodes includes a node processor and a node memory;
wherein the information handling system is configured to:
execute, at a particular node of the group of nodes, a container registry that includes images for a plurality of containerized workloads;
cause all nodes of the group of nodes to execute a containerized workload that is an image holder; and
upgrade the container registry from an old image to a new image by:
storing the old image and the new image in a local physical storage resource of the particular node;
executing, by the image holder, the new image;
shutting down the container registry that is executing the old image; and
starting a new container registry, wherein the new container registry is configured to execute the new image.

2. The information handling system of claim 1, wherein the group of nodes comprises a hyper-converged infrastructure (HCI) cluster.

3. The information handling system of claim 1, wherein the containerized workloads are created in accordance with a Docker standard.

4. The information handling system of claim 1, further configured to prevent the new container registry from attempting to pull an image from the container registry.

5. The information handling system of claim 1, wherein an imagePullPolicy of the container registry is set to a value of IfNotPresent.

6. The information handling system of claim 1, wherein causing all nodes of the group of nodes to execute the image holder comprises using a DaemonSet.

7. A method comprising:
an information handling system that includes a group of nodes including at least one node executing, at a particular node of the group of nodes, a container registry that includes images for a plurality of containerized workloads;
the information handling system causing all nodes of the group of nodes to execute a containerized workload that is an image holder; and
the information handling system upgrading the container registry from an old image to a new image by:
storing the old image and the new image in a local physical storage resource of the particular node;
executing, by the image holder, the new image;
shutting down the container registry that is executing the old image; and
starting a new container registry, wherein the new container registry is configured to execute the new image.

8. The method of claim 7, wherein the group of nodes comprises a hyper-converged infrastructure (HCI) cluster.

9. The method of claim 7, wherein the containerized workloads are created in accordance with a Docker standard.

10. The method of claim 7, further comprising preventing the new container registry from attempting to pull an image from the container registry.

11. The method of claim 7, wherein an imagePullPolicy of the container registry is set to a value of IfNotPresent.

12. The method of claim 7, wherein causing all nodes of the group of nodes to execute the image holder comprises using a DaemonSet.

13. An article of manufacture comprising a non-transitory, computer-readable medium having computer-executable instructions thereon that are executable by a processor of an information handling system that includes a group of nodes including at least one node for:
executing, at a particular node of the group of nodes, a container registry that includes images for a plurality of containerized workloads;
causing all nodes of the group of nodes to execute a containerized workload that is an image holder; and
upgrading the container registry from an old image to a new image by:
storing the old image and the new image in a local physical storage resource of the particular node;
executing, by the image holder, the new image;
shutting down the container registry that is executing the old image; and
starting a new container registry, wherein the new container registry is configured to execute the new image.

14. The article of manufacture of claim 13, wherein the group of nodes comprises a hyper-converged infrastructure (HCI) cluster.

15. The article of manufacture of claim 13, wherein the containerized workloads are created in accordance with a Docker standard.

16. The article of manufacture of claim 13, wherein the instructions are further executable for preventing the new container registry from attempting to pull an image from the container registry.

17. The article of manufacture of claim 13, wherein an imagePullPolicy of the container registry is set to a value of IfNotPresent.

18. The article of manufacture of claim 13, wherein causing all nodes of the group of nodes to execute the image holder comprises using a DaemonSet.
